(19) United States
(12) Patent Application Publication
(10) Pub. No.: US 2017/0129291 A1
(43) Pub. Date: May 11, 2017

(54) PNEUMATIC TIRE AND METHOD FOR MANUFACTURING THE SAME

(71) Applicant: TOYO TIRE & RUBBER CO., LTD., Osaka-shi, Osaka (JP)

(72) Inventor: Takashi Miyasaka, Osaka (JP)

(73) Assignee: TOYO TIRE & RUBBER CO., LTD., Osaka-shi, Osaka (JP)

(21) Appl. No.: 15/317,580

(22) PCT Filed: Mar. 13, 2015
(86) PCT No.: PCT/JP2015/001414

§ 371 Date: Dec. 9, 2016

(30) Foreign Application Priority Data
Jul. 17, 2014 (JP) 2014-147023

(51) Int. Cl. B60C 15/06; C08K 3/04; B29D 30/18; C08J 3/22; B29D 30/06; B60C 15/00

(52) U.S. Cl. CPC B60C 15/0628; B29D 30/06; B60C 15/0027; B29D 30/18; C08J 3/226; C08K 3/04; B60C 2015/0642; C08J 2307/02

(57) ABSTRACT

Edge separation in a turned-up end portion (5E) of a carcass ply (5) is suppressed. In a pneumatic tire comprising a bead core (4) embedded in a bead portion (3) and a carcass ply (5) turned up and locked around the bead core (4), a rubber sheet (10) is prepared using a wet masterbatch containing natural rubber and/or polyisoprene rubber and carbon black, and the rubber sheet (10) is arranged on at least one of front and back sides of the turned-up end portion (5E) of the carcass ply (5).

### TECHNICAL FIELD

The present invention relates to a pneumatic tire.

### BACKGROUND ART

Both end portions of a carcass ply are generally turned up and locked so as to wind up around a bead core in a bead portion in a pneumatic tire. The bead portion has a problem that separation is liable to occur by local repeating strain at a turned-up end portion of the carcass ply.

To suppress the separation, Patent Document 1 discloses that a reinforcing rubber layer comprising a rubber composition containing hydrogenated NBA is provided at a turned-up end portion of a carcass ply, and additionally an adhesive rubber layer comprising a rubber composition containing diene rubber is arranged adjacent to the reinforcing rubber layer.

As the technology of arranging a rubber sheet around a turned-up end portion of a carcass ply, Patent Document 2 discloses that a side reinforcing rubber layer reinforced with a resin having a melting point of 200° C. or lower is arranged on the outside of the turned-up end portion of the carcass ply, or between the inside of the turned-up end portion and a bead filler. However, this document has an object to reduce air inclusion failure during vulcanization molding while enhancing driving stability by the side reinforcing rubber layer, and the improvement effect of the separation at the turned-up end portion of the carcass ply is insufficient.

On the other hand, using a wet masterbatch is known as the technology for improving dispersibility of carbon black in a rubber (see Patent Documents 3 and 4). The wet masterbatch is obtained by mixing a slurry solution obtained by dispersing carbon black in a dispersion medium such as water with a rubber latex solution, followed by coagulating and drying. It is not conventionally known to use the wet masterbatch in a rubber sheet that suppresses separation at a turned-up end portion of a carcass ply, and sufficient effect of suppressing separation has not been achieved.

### PRIOR ART DOCUMENTS

### Patent Document

Patent Document 1: JP-A-2000-318405

Patent Document 2: JP-A-2000-247115

Patent Document 3: JP-A-2007-197549

Patent Document 4: Japanese Patent No. 4738551

### SUMMARY OF THE INVENTION

### Problems that the Invention is to Solve

The present embodiment has an object to provide a pneumatic tire that can suppress edge separation at a turned-up end portion of a carcass ply.

### Means for Solving the Problems

A method for manufacturing a pneumatic tire according to the present embodiment comprises preparing a rubber sheet using a wet masterbatch containing natural rubber and/or polyisoprene rubber and carbon black, arranging the rubber sheet on at least one of front and back sides at a turned-up end portion of a carcass ply in manufacturing a green tire in which the carcass ply is turned up around a bead core, and vulcanization-molding the green tire obtained.

A pneumatic tire according to the present embodiment comprises a bead core embedded in a bead portion, a carcass ply turned up and locked around the bead core, and a rubber sheet disposed on at least one of front and back sides at a turned-up end portion of the carcass ply, wherein the rubber sheet comprises a rubber composition containing a wet masterbatch containing natural rubber and/or polyisoprene rubber and carbon black.

### Advantageous Effects of the Invention

According to the present embodiment, breakage (that is, edge separation) due to local strain fatigue at the turned-up end portion can be effectively suppressed by arranging the rubber sheet having carbon black highly dispersed therein around the turned-up end portion of the carcass ply.

### BRIEF DESCRIPTION OF THE DRAWINGS

FIG. 1 is a half cross-section view of a pneumatic tire according to one embodiment.

FIG. 2 is an enlarged cross-sectional view of a bead portion of the tire of FIG. 1.

FIG. 3 is an enlarged cross-sectional view of a bead portion of other embodiment.

FIG. 4 is an enlarged cross-sectional view of a bead portion of another embodiment.

FIG. 5 is an enlarged cross-sectional view of a bead portion of still another embodiment.

### MODE FOR CARRYING OUT THE INVENTION

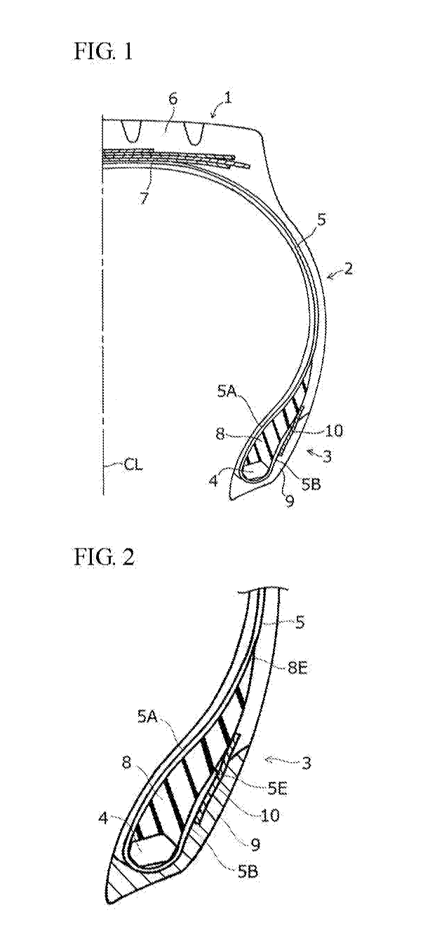

FIG. 1 shows a pneumatic tire according to one embodiment, and a cross-section of a pneumatic radial tire for heavy load is shown. The pneumatic tire comprises a tread portion (1), a pair of right and left sidewall portions (2) extending inward in a radial direction from both end portions of the tread portion, and a pair of right and left bead portions (3) provided inside in a radial direction of the sidewall portions (2). Ring-shaped bead cores (4) are embedded in a pair of the bead portions (3), respectively. In the drawing, CL indicates a tire equator. In this example, the tire has a bilaterally symmetrical structure to the tire equator CL.

At least one carcass ply (5) toroidally extending between a pair of the bead cores (4) is embedded in the pneumatic tire. In this example, the carcass ply (5) is one, but two or more carcass plies may be provided. The carcass ply (5) extends to the bead portion (3) from the tread portion (1) through the sidewall portion (2), and is locked by turning up the end portion of the carcass ply (5) around the bead core (4) in the bead portion (3). In this example, the end portion of the carcass ply (5) is locked by turning up to the outside from the inside in a tire width direction around the bead core (4). The carcass ply (5) comprises a carcass cord comprising a steel cord, an organic fiber cord or the like, and a covering rubber covering the carcass cord. The carcass cord is arranged at substantially right angle to a tire circumferential direction.

A belt (7) comprising at least two belt plies is provided between the carcass ply (5) and a tread rubber portion (6) at an outer circumferential side in a radial direction of the carcass ply (5) in the tread portion (1).

A bead filler (8) made of a hard rubber is provided on an outer circumference (that is, outer circumferential side in a radial direction) of the bead core (4) between a main body (5A) of the carcass ply (5) and its turned-up portion (5B). The bead filler (8) has a triangular cross-section formed such that its width is gradually decreased toward the outside in a tire radial direction.

The bead portion (3) is provided with a rubber chafer (9) as a rubber portion constituting an outer surface portion of a portion in contact with a rim flange not shown. The rubber chafer (9) is arranged opposing to the rim flange in the state that a pneumatic tire has been mounted on a regular rim, constitutes an outer surface portion of the bead portion coming into contact therewith, and is called a rim strip. In more detail, the rubber chafer (9) is provided so as to cover the outside in a tire width direction of the turned-up portion (5B) of the carcass ply (5). Therefore, the turned-up portion (5B) is interposed between the bead filler (8) and the rubber chafer (9).

As enlarged and shown in FIG. 2, a rubber sheet (10) for suppressing separation at a turned-up portion (5E) that is a tip (outer end in a tire radial direction) of the turned-up portion (5B) of the carcass ply (5) is arranged around the turned-up portion (5E). When a rubber sheet having excellent fatigue resistance performance described in detail below is used as the rubber sheet (10), separation due to strain generated at the turned-up end portion (5E) of the carcass ply (5) can be suppressed.

The rubber sheet (10) is provided over the entire circumference in a tire circumferential direction by bringing into contact with the turned-up end portion (5E) of the carcass ply (5). In this example, the rubber sheet is arranged at a side opposite the bead filler (8) in the turned-up end portion (5E) (that is, the side of the rubber chafer (9)). Therefore, the rubber sheet (10) is interposed between the turned-up portion (5B) and the chafer (9). The rubber sheet (10) extends along the outer surface of the bead filler (8) toward the outside in a tire radial direction beyond the turned-up end portion (5E). Therefore, the rubber sheet (10) is provided so as to cover the turned-up end portion (5E) from the outside in a tire radial direction. In this example, the turned-up end portion (5E) is located inside in a tire radial direction than a tip (8E) of the bead filler (8), but may be extended outside in a tire radial direction beyond the tip (8E).

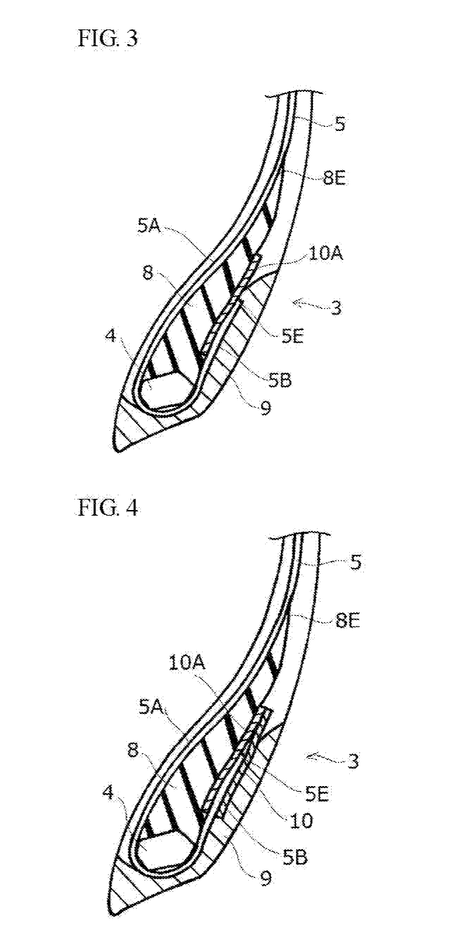

The rubber sheet can be arranged on at least one of front and back sides (that is, inside and outside) of the turned-up end portion (5E). That is, the rubber sheet can be arranged on at least one of the bead filler (8) side and the rubber chafer (9) side in the turned-up end portion (5E). FIG. 3 is an example in which the rubber sheet (10A) is arranged on the bead filler (8) side in the turned-up end portion (5E). As a result, the rubber sheet (10A) is interposed between the turned-up portion (5B) and the bead filler (8). The rubber sheet (10A) extending outside in a tire radial direction beyond the turned-up end portion (5E) is the same as the rubber sheet (10) of FIG. 2.

FIG. 4 is an example in which the rubber sheets (10) and (10A) are arranged on the front and back sides in the turned-up end portion (5E) of the carcass ply (5), that is, both the bead filler (8) side and the rubber chafer (9) side. In detail, the outer rubber sheet (10) interposed between the turned-up portion (5B) and the rubber chafer (9), and the inner rubber sheet (10A) interposed between the turned-up portion (5B) and the bead filler (8) are provided. Therefore, the turned-up end portion (5E) is provided in the state of being sandwiched between the outer rubber sheet (10) and the inner rubber sheet (10A).

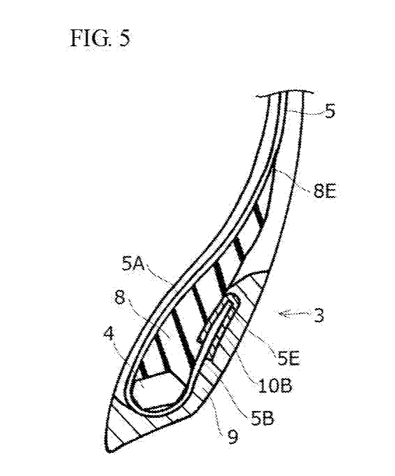

FIG. 5 is an example in which a rubber sheet (10B) is adhered in the form of wrapping the turned-up end portion (5E) of the carcass ply (5). In detail, the rubber sheet (10B) is turned up so as to wrap the turned-up end portion (5E). Therefore, the rubber sheet (10B) is provided on both the bead filler (8) side and the rubber chafer (9) side in the turned-up end portion (5E) of the carcass ply (5). The separation at the turned-up end portion (5E) can be further effectively suppressed by arranging the rubber sheets (10), (10A) and (10B) so as to wrap the turned-up end portion (5E) as shown in FIGS. 4 and 5.

In the present embodiment, the rubber sheet comprises a rubber composition containing a wet masterbatch containing natural rubber and/or polyisoprene rubber and carbon black. Fatigue resistance performance can be enhanced by forming the rubber sheet using the wet masterbatch containing carbon black highly dispersed herein.

The pneumatic tire of the present embodiment is obtained by preparing the rubber sheet using a wet masterbatch containing natural rubber and/or polyisoprene rubber and carbon black, arranging the rubber sheet around a turned-up end portion of a carcass ply to manufacture a green tire, and vulcanization-molding the green tire. Each step is described in detail below.

### (Preparation Process of Wet Masterbatch)

The wet master batch can be prepared using a rubber latex solution containing natural rubber (NR) and/or polyisoprene rubber (IR) and a slurry solution of carbon black, and the preparation method is not particularly limited. The wet masterbatch is generally obtained by mixing a slurry solution obtained by dispersing carbon black in a dispersion medium with a rubber latex solution, followed by coagulating and drying.

A latex solution of polyisoprene rubber that is a synthetic resin may be used as the rubber latex solution, but it is preferred to use a natural rubber latex solution. The case of NR that is a preferred embodiment is described below, but the same can be applied to IR. Concentrated latex, fresh latex called field latex, and the like can be used as the natural rubber latex solution, and as necessary, the latex obtained by adding water to adjust a concentration may be used. A natural rubber and/or a diene rubber latex solution other than polybutadien rubber may be concurrently used so long as the effect is not lost.

The carbon black can use carbon blacks such as SAF grade (N100 Series), ISAF grade (N200 Series), HAF grade (N300 Series), FEF grade (N500 Series) and GPF grade (N600 Series) (those are ASTM grade), and carbon black of HAF grade is more preferably used.

The preparation process of the wet masterbatch according to the preferred embodiment includes a step (A) of adding a part of a natural rubber latex solution in dispersing carbon black in a dispersion medium, thereby producing a slurry solution containing carbon black having rubber latex particles adhered thereto, and a step (B) of mixing the slurry solution with the remaining rubber latex solution, thereby producing a carbon black-containing rubber latex solution having rubber latex particles adhered to the carbon black, and a step (C) of adding an acid, thereby coagulating the carbon black-containing rubber latex solution.

### (1) Step (A)

In the step (A), the natural rubber latex solution may be previously mixed with the dispersion medium, and carbon black may be added thereto and dispersed therein. Furthermore, the carbon black may be added to the dispersion medium, and then dispersed in the dispersion medium while adding the natural rubber latex solution in a predetermined addition rate. Alternatively, the carbon black may be added to the dispersion medium, and then dispersed in the dispersion medium while adding a certain amount of the natural rubber latex solution in several times. The slurry solution containing carbon black having natural rubber latex particles adhered thereto can be produced by dispersing the carbon black in the dispersion medium in the state that the natural rubber latex solution is present.

Water is preferably used as the dispersion medium, but, for example, water containing an organic solvent may be used.

The amount of the natural rubber latex solution added in the step (A) is, for example, from 0.5 to 50 mass % based on the entire amount of the natural rubber latex solution used (the entire amount of the natural rubber latex solution added in the step (A) and the step (B)). Furthermore, the amount of a solid content (rubber) in the natural rubber latex solution added in the step (A) is preferably from 0.5 to 10%, and more preferably from 1 to 6%, in mass ratio to the carbon black.

A method for mixing carbon black with the dispersion medium in the presence of the natural rubber latex solution in the step (A) includes a method of dispersing carbon black using an ordinary disperser such as a high shear mixer, a homo-mixer, a ball mill, a bead mill, a high-pressure homogenizer, an ultrasonic homogenizer or a colloid mill.

In one embodiment, it is preferred to adjust pH of the slurry solution containing carbon black having rubber latex particles adhered thereto obtained after the step (A) to 7.1 or higher. The adjustment of pH to 7.1 or higher makes it difficult to cause adsorption and coagulation of mutual rubber latex particles adhered to the surface of carbon black. As a result, the rubber latex can be coagulated while maintaining high dispersion performance of the carbon black, and fatigue resistance performance of the rubber sheet can be enhanced. The adjustment method of pH of the slurry solution is not particularly limited. The method is, for example, a method of adjusting pH by adding a base such as sodium hydroxide, potassium hydroxide, sodium carbonate, sodium hydrogen carbonate or ammonia to the slurry solution. The upper limit of pH of the slurry solution obtained after the step (A) is not particularly limited. The upper limit is, for example, about 9.0.

### (2) Step (B)

In the step (B), a method of mixing the slurry solution with the remaining natural rubber latex solution in a liquid phase is not particularly limited. The method is, for example, a method of mixing using an ordinary disperser such as a high shear mixer, a homo-mixer, a ball mill, a bead mill, a high-pressure homogenizer, an ultrasonic homogenizer or a colloid mill. As necessary, the whole mixing system such as a disperser may be heated in mixing.

It is preferred that the remaining natural rubber latex solution has a solid content (rubber) concentration higher than that of the natural rubber latex solution added in the step (A). Specifically, the solid content (rubber) concentration is preferably from 10 to 60 mass %, and more preferably from 20 to 30 mass %.

### (3) Step (C)

Examples of the acid acting as a coagulating agent in the step (C) include formic acid and sulfuric acid that are generally used for the coagulation of a rubber latex solution.

In the step (C), pH of the carbon black-containing rubber latex solution before adding an acid is adjusted to preferably from 7.5 to 8.5, and more preferably from 8.0 to 8.5. By the adjustment, the rubber latex can be coagulated while maintaining high dispersion performance of carbon black. In detail, when the pH is 7.5 or higher, self-coagulation of rubber latex particles can be suppressed in the rubber latex solution, and fatigue resistance performance of the rubber sheet can be enhanced. Furthermore, when the pH is 8.5 or lower, electrostatic minus charge of rubber latex particles is prevented from becoming excessively large, and affinity with carbon black particles can be enhanced. As a result, dispersibility of carbon black is increased, and fatigue resistance performance of the rubber sheet can be improved. Thus, examples of the method for adjusting pH include a method of appropriately heating and vacuum devolatilizing a mixed solution obtained in producing the carbon black-containing rubber latex solution, and a method of appropriately adding a pH regulator such as citric acid, lactic acid or sodium hydrogen carbonate.

The wet masterbatch is obtained by dehydrating and drying a solution containing coagulated matters after a coagulation stage in the step (C). As the dehydrating and drying method, various drying apparatuses such as an oven, a vacuum drier and an air drier may be used, and dehydration and drying may be conducted while applying mechanical shear force using an extruder.

The wet masterbatch obtained after the step (C) contains carbon black in an amount of preferably from 30 to 100 parts by mass, and more preferably from 40 to 80 parts by mass, per 100 parts by mass of natural rubber.

A peptizer may be added in the step of preparing the wet masterbatch using the natural rubber latex solution and the carbon black slurry solution. The addition of a peptizer makes it possible to further highly disperse carbon black and can further improve fatigue resistance performance of the rubber sheet. The peptizer can use materials generally used as a peptizer, and examples thereof include xylyl mercaptan, β-naphthyl mercaptan, 2,2-dibenzamide diphenyldisulfide, and a zinc salt of o-benzamide thiophenol. Those can be used alone or as mixtures of two or more thereof.

The peptizer may be previously added to the natural rubber latex solution, may be previously added to the carbon black slurry solution (may be added when preparing the slurry solution in the step (A)), and may be added during or after mixing the natural rubber latex solution with the carbon black slurry solution. The amount of the peptizer added is not particularly limited, and may be, for example, from 0.01 to 2.0 parts by mass, and from 0.5 to 1.0 part by mass, per 100 parts by mass of the natural rubber.

The wet masterbatch may contain various additives generally used in rubber industries so long as the effect of the present embodiment is not impaired.

### (Preparation Step of Rubber Sheet)

A rubber sheet is prepared from the rubber composition containing the wet masterbatch obtained, in the preparation process of a rubber sheet. The rubber composition for the rubber sheet can contains various additives such as a vulcanizing agent, a vulcanization accelerator, silica, a silane coupling agent, zinc oxide, stearic acid, an age resistor, a softener such as a wax or an oil, and a processing aid, in addition to the wet masterbatch.

Examples of the vulcanizing agent include sulfur components such as powdered sulfur, precipitated sulfur, colloidal sulfur, insoluble sulfur and highly dispersible sulfur. Although not particularly limited, the amount of the vulcanizing agent added is preferably from 0.5 to 10 parts by mass, and more preferably from 1 to 6 parts by mass, per 100 parts by mass of the rubber component. The amount of the vulcanization accelerator added is preferably from 0.1 to 7 parts by mass, and more preferably from 0.5 to 5 parts by mass, per 100 parts by mass of the rubber component.

The rubber component in the rubber composition may be natural rubber and/or polyisoprene rubber alone, that are added as the wet masterbatch, but other diene rubber may be added in a range that the effect is not impaired. The amount of the natural rubber and/or polyisoprene rubber is 50 parts by mass or more, preferably 80 parts by mass or more, and particularly preferably 100 parts by mass, in 100 parts by mass of the rubber component.

It is preferred in the rubber composition that the entire amount of carbon black is added as a wet masterbatch. The amount of the carbon black added in the rubber composition is preferably from 30 to 100 parts by mass, and more preferably from 40 to 80 parts by mass, per 100 parts by mass of the rubber component.

The rubber composition may further contain a phenol type thermosetting resin and a methylene donor as a hardener thereof. Examples of the phenol type thermosetting resin include resins obtained by the condensation of at least one phenol compound selected from the group consisting of phenol, resorcin and alkyl derivatives of those, with aldehyde such as formaldehyde. Examples of the alkyl derivatives include cresol, xylenol, nonylphenol and octylphenol. Specific examples of the phenol type thermosetting resin include various novolac phenol resins such as an unmodified phenol resin obtained by the condensation of phenol with formaldehyde, an alkyl-substituted phenol resin obtained by the condensation of an alkyl phenol such as cresol or xylenol with formaldehyde, a resorcin-formaldehyde resin obtained by the condensation of resorcin with formaldehyde, and a resorcin-alkyl phenol cocondensated formaldehyde resin obtained by the condensation of resorcin and alkyl phenol with formaldehyde.

Hexamethylene tetramine and/or melamine derivative are used as a methylene donor that is added as a hardener of the phenol type thermosetting resin. The melamine derivative includes at least one selected from the group consisting of hexamethoxymethylmelamine, hexamethylolmelamine pentamethyl ether and polyhydric methylolmelamine.

The amount of the phenol type thermosetting resin added is preferably from 0.5 to 10 parts by mass, and more preferably from 1 to 5 parts by mass, per 100 parts by mass of the rubber component. The amount of the melamine donor added is preferably from 0.5 to 10 parts by mass, and more preferably from 1 to 5 parts by mass, per 100 parts by mass of the rubber component.

The rubber composition can be prepared by kneading the necessary components according to the conventional methods using a mixing machine generally used, such as Banbury mixer, a kneader or rolls. The method for preparing a rubber sheet using the rubber composition obtained is that the rubber composition is formed into a sheet shape using, for example, an extruder. The thickness of the rubber sheet is not particularly limited. From the standpoint of fatigue resistance performance, the thickness is preferably 0.1 mm or more, more preferably from 0.3 to 5.0 mm, and still more preferably from 0.5 to 2.0 mm.

### (Manufacturing Step of Green Tire)

The manufacturing step of a green tire manufactures a green tire (unvulcanized tire) by arranging the unvulcanized rubber sheet on at least one of front and back sides in the turned-up end portion (5E) of the carcass ply (5).

The manufacturing process of the green tire can apply the conventional molding method using a molding drum. For example, the green tire can be molded by sequentially adhering an inner liner and a carcass ply to the molding drum, mounting a bead core and a bead filler on both end portions of the carcass ply, turning up the both end portions of the carcass ply around the bead core, adhering a rubber chafer and a side wall rubber, expanding a diameter of the molding drum, and adhering a belt layer and a tread rubber to a crown part of the carcass ply.

In the present embodiment, the rubber sheets (10), (10A) and (10B) are adhered to a turned-up portion (5B), or a bead filler (8) or rubber chafer (9) to be laminated on the turned-up portion (5B) in winding up and turning up the carcass ply (5), during the manufacturing of the green tire.

### (Vulcanization-Molding Step)

The vulcanization-molding step vulcanization-molds the green tire obtained above. The vulcanization-molding can use the conventional method. That is, a pneumatic tire according to the embodiment is obtained by setting the green tire to a vulcanization mold, and vulcanization-molding the green tire at a temperature of, for example, from 140 to 180° C., according to the conventional method.

According to the present embodiment described above, the rubber sheet contains carbon black highly dispersed therein, and the rubber sheet is arranged around the turned-up edge of the carcass ply. This can effectively suppress edge separation due to local strain fatigue at the turned-up end portion. The present embodiment can be used in various pneumatic tires, and is preferably applied to tires for heavy load used in large-size cars such as trucks and buses, in which edge separation is liable to become a problem.

### EXAMPLES

Examples of the present invention are described below, but the present invention is not construed as being limited to those examples. Raw materials used and evaluation methods are as follows.

### (Raw Materials Used)

Carbon black: N330, “SEAST 3” manufactured by Tokai Carbon Co., Ltd.

Natural rubber latex solution: Natural rubber concentrated latex solution “LA-NR” (DRC (Dry Rubber Content)=60%) manufactured by Regitex

Coagulating agent: Formic acid (first grade 85%, diluted to 10% solution to adjust pH to 1.2) manufactured by Nacalai Tesque

Peptizer: “NOCTIZER SD” manufactured by Ouchi Shinko Chemical Industrial Co., Ltd.

Phenol type resin: Resorcin-alkyl phenol-formalin copolymer resin, “SUMIKANOL 620” manufactured by Sumitomo Chemical Co., Ltd.

Zinc flower: “Zinc Flower #3” manufactured by Mitsui Mining & Smelting Co., Ltd.

Age resistor: N-phenyl-N′-(1,3-dimethylbutyl)-p-phenylenediamine, “6PPD” manufactured by Monsanto

Insoluble sulfur: “CRYSTEX OT-20” manufactured by Akzo

Vulcanization accelerator: Sulfenamide type, N,N-dicyclohexyl-2-benzothiazolyl sulfenamide, “NOCCELER DZ-G” manufactured by Ouchi Shinko Chemical Industrial Co., Ltd.

Methylene donor: Hexamethoxylmethylmelamine., “CYLET 963L” manufactured by Nihon Cytex Industries Inc.

### (Measurement and Evaluation Methods)

pH: Evaluated by portable pH meter HM-30P manufactured by DKK-Toa Corporation according to JIS Z8802. The pH measurement of the slurry solution obtained in the step (A) was conducted under the condition of 25° C., and the pH measurement of the carbon black-containing rubber latex solution before adding the acid in the step (C) was conducted at a liquid temperature of a mixed solution shown in Table 1.

Fatigue resistance performance: Evaluated according to JIS K6260. The measurement was conducted under the condition of a temperature of 23° C., and the number until crack growth reaches 2 mm was obtained. The performance was indicated by an index as the value of Comparative Example 1 being 100. The larger the value shows good fatigue resistance performance.

Tire durability: Experimentally manufactured tire was run on a drum tester under the conditions of air inner pressure: 0.9 MPa, load: 53 kN and speed: 40 km/hr until tire failure occurs. Regarding the running time until a failure of a bead portion occurs, Comparative Example 1 was standard. The case that the running time is 10% or more shorter than Comparative Example 1 was defined as “D (poor)”, the case that the running time is more than 10% and less than 15% longer than Comparative Example 1 was defined as “B (good)”, the case that the running time 15% or more longer than Comparative Example 1 was defined as “A (very good)”, and the case that the difference of the running time to Comparative Example 1 is less than 10% was defined as “C (equivalent)”.

### Example 1

50 Parts by mass of carbon black were added to 954.8 parts by mass of a natural rubber latex solution having a solid content (rubber) concentration adjusted to 0.5 mass %, and the carbon black was dispersed using ROBOMIX manufactured by PRIMIX Corporation (conditions of ROBOMIX: 50° C., 9000 rpm, 30 minutes). Thus, a slurry solution containing carbon black having natural rubber latex particles adhered thereto was produced (Step A). The pH of the slurry solution obtained in the step A is shown in Table 1. The amount of the 0.5 mass % natural rubber latex solution used was set such that the amount of the carbon black to the total of water and carbon black is 5 mass % in the slurry solution obtained in the step A (the same in the preparation process of the wet masterbatch in the following examples).

The remaining natural rubber latex solution (adjusted by adding water at a temperature of 25° C. such that the solid content concentration is 25 mass %) was added to the slurry solution produced in the step A such that the total solid content amount of the remaining natural rubber latex solution and the natural rubber latex solution used in the step A is 100 parts by mass. The resulting mixture was mixed using a household mixer SM-L56 manufactured by SANYO (mixer conditions: 11300 rpm, 30 minutes). Thus, a carbon black-containing natural rubber latex solution was produced (Step B). The pH of the natural rubber latex solution to be added in the step B is shown in Table 1.

The carbon black-containing natural rubber latex solution produced in the step B was heated so as to reach a liquid temperature of the mixed solution shown in Table 1, and the pH of the carbon black-containing natural rubber latex solution before coagulation was adjusted to a value shown in Table 1. Thereafter, a 10 mass % formic acid aqueous solution was added as a coagulating agent until the pH reaches 4 (Step C). After solid-liquid separation of the coagulated matter, the coagulated matter was dehydrated (180° C.) using a squeezer type single screw extrusion dehydrator (V-02 manufactured by Suehiro EPM Corporation), and further dried and plasticized (200° C.) using the extrusion hydrator until the water content is 1.5% or less. Thus, a wet masterbatch was obtained. The wet masterbatch contains 50 parts by mass of carbon black per 100 parts by mass of natural rubber as shown in the formulation of the masterbatch in Table 1.

B type Banbury mixer (Kobe Steel, Ltd.) was used, and according to the formulation of the rubber composition of Table 1, components excluding sulfur, a vulcanization accelerator and a methylene donor were added to and mixed with the wet masterbatch (discharge temperature: 160° C.) in a first step (non-processing mixing step). Sulfur, a vulcanization accelerator and a methylene donor were then added to and mixed with the mixture obtained (discharge temperature: 100° C.) in a second step (final mixing step). Thus, a rubber composition was prepared.

A rubber sheet having a thickness of 1.0 mm was prepared from the rubber composition obtained. The rubber sheet was interposed between the turned-up portion of a carcass ply having steel cords embedded therein and a rubber chafer as shown in FIG. 2, and a pneumatic radial tire for heavy load (tire size: 11R22.5) was vulcanization-molded according to the conventional method. The rubber sheet had a width of 20 mm toward a tread side and a width of 25 mm toward a bead tow side, from the turned-up end portion of the carcass ply, the total width being 45 mm, and was arranged over the entire circumference in a tire circumferential direction.

### Comparative Examples 1 and 2

A rubber composition was prepared by dry mixing according to the formulation of a rubber composition shown in Table 1 without preparing a wet master batch. A rubber sheet was prepared using the rubber composition and a tire was manufactured experimentally, in the same manner as in Example 1. The dry masterbatch in Comparative Example 2 is a masterbatch obtained by adding 50 parts by mass of carbon black to 100 parts by mass of natural rubber, followed by kneading, using B type Banbury mixer (Kobe Steel, Ltd.). RSS3 was used as natural rubber in Comparative Examples 1 and 2.

### Examples 2 to 8

Wet masterbatch was prepared in the same manner as in Example 1, except that the amount of carbon black added in the step A, the pH of the carbon black-containing slurry solution obtained after the step A, the pH of the natural rubber latex solution to be added in the step B, the liquid temperature of the carbon black-containing natural rubber latex solution (liquid temperature of a mixed solution) produced in the step B, and the pH of the carbon black-containing rubber latex solution before coagulation in the step C were changed to the values shown in Table 1. Using the wet masterbatch obtained, a rubber composition was prepared according to the formulation of a rubber composition in Table 1, a rubber sheet was produced using the rubber composition, and a tire was manufactured experimentally using the rubber sheet, in the same manners as in Example 1.

### Examples 9 to 11

A tire was manufactured experimentally in the same manners as in Example 1, except that the arrangement of the rubber sheet was changed as shown in Table 1. In detail, in Example 9, the rubber sheet having a thickness of 1.0 mm was interposed between the turned-up portion of the carcass ply and the bead filler (the rubber sheet had a width of 20 mm toward a tread side and a width of 25 mm toward a bead tow side, from the turned-up end portion of the carcass ply, the total width being 45 mm) as shown in FIG. 3. In Example 10, two rubber sheets each having a thickness of 1.0 mm were used, and were interposed between the turned-up portion of the carcass ply and the bead filler and between the turned-up portion of the carcass ply and the rubber chafer, respectively (the rubber sheet had a width of 20 mm toward a tread side and a width of 25 mm toward a bead tow side, from the turned-up end portion of the carcass ply, the total width being 45 mm) as shown in FIG. 4. In Example 11, a rubber sheet having a thickness of 1.0 mm was turned up and arranged so as to wrap the turned-up end portion of the carcass ply (the rubber sheet had a width of 20 mm at a bead filler side and a width of 25 mm at a rubber chafer side, toward a bead tow side from the turned-up end portion of the carcass ply, the total width being 45 mm) as shown in FIG. 5.

### Example 12

A wet masterbatch, a rubber composition and a rubber sheet were prepared in the same manners as in Example 1, except that when the slurry solution was mixed with the remaining natural rubber latex solution in the step B, the peptizer was added in an amount of 0.1 part by mass per 100 parts by mass of natural rubber, and a tire was manufactured experimentally.

Fatigue resistance performance of each rubber composition obtained above was evaluated using a test piece vulcanized at 150° C. for 30 minutes, and drum durability of each tire manufactured experimentally was evaluated. The results are shown in Table 1.

As shown in Table 1, Comparative Example 2 in which natural rubber was formed into a dry masterbatch was that the improvement effect of fatigue resistance performance is poor and the improvement effect of drum durability was not obtained, as compared with Comparative Example 1 as a control. On the other hand, in Examples 1 to 12 in which the rubber sheet prepared using a wet masterbatch was arranged around the turned-up end portion of the carcass ply, fatigue resistance performance of the rubber sheet was excellent, and as a result, drum durability was improved. Particularly, fatigue resistance performance of the rubber sheet was remarkably improved in Examples 1 to 4 and 9 to 12. Furthermore, drum durability was remarkably improved in Examples 10 and 11 in which the rubber sheet was arranged so as to wrap the turned-up end portion of the carcass ply. Furthermore, fatigue resistance performance of the rubber sheet was further improved and drum durability was excellent, in Example 12 in which a peptizer was added when preparing a wet masterbatch.

TABLE 1

| | Com. | Com. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | Ex. 1 | Ex. 2 | 1 | 2 | 3 | 4 | 5 | 6 | 7 | 8 | 9 | 10 | 11 | 12 |
| Preparation conditions of wet | | | | | | | | | | | | | | |
| masterbatch | | | | | | | | | | | | | | |
| pH of carbon black-containing | — | — | 7.4 | 7.4 | 7.4 | 7.4 | 7.4 | 7.4 | 5.1 | 6.3 | 7.4 | 7.4 | 7.4 | 7.4 |
| slurry solution | | | | | | | | | | | | | | |
| pH of natural rubber latex | — | — | 10.6 | 9.7 | 9.1 | 10.6 | 10.6 | 10.6 | 10.6 | 10.6 | 10.6 | 10.6 | 10.6 | 10.6 |
| solution | | | | | | | | | | | | | | |
| Liquid temperature of mixed | — | — | 81 | 60 | 62 | 82 | 61 | 97 | 31 | 60 | 81 | 81 | 81 | 81 |
| solution (° C.) | | | | | | | | | | | | | | |
| pH of carbon black-containing | — | — | 8.4 | 8.3 | 8.1 | 8.4 | 9.1 | 7.2 | 7.3 | 7.6 | 8.4 | 8.4 | 8.4 | 8.4 |
| natural rubber latex solution | | | | | | | | | | | | | | |
| before coagulation | | | | | | | | | | | | | | |
| Composition of wet masterbatch | | | | | | | | | | | | | | |
| (parts by mass) | | | | | | | | | | | | | | |
| Natural rubber (solid content) | — | — | 100 | 100 | 100 | 100 | 100 | 100 | 100 | 100 | 100 | 100 | 100 | 100 |
| Carbon black | — | — | 50 | 50 | 50 | 45 | 50 | 50 | 50 | 50 | 50 | 50 | 50 | 50 |
| Peptizer | — | — | — | — | — | — | — | — | — | — | — | — | — | 0.1 |
| Formulation of rubber | | | | | | | | | | | | | | |
| composition (parts by mass) | | | | | | | | | | | | | | |
| Natural rubber | 100 | — | — | — | — | — | — | — | — | — | — | — | — | — |
| Carbon black | 50 | — | — | — | — | 5 | — | — | — | — | — | — | — | — |
| Dry masterbatch | — | 150 | — | — | — | — | — | — | — | — | — | — | — | — |
| Wet masterbatch | — | — | 150 | 150 | 150 | 145 | 150 | 150 | 150 | 150 | 150 | 150 | 150 | 150 |
| Zinc flower | 8 | 8 | 8 | 8 | 8 | 8 | 8 | 8 | 8 | 8 | 8 | 8 | 8 | 8 |
| Phenol type resin | 2 | 2 | 2 | 2 | 2 | 2 | 2 | 2 | 2 | 2 | 2 | 2 | 2 | 2 |
| Age resister | 2 | 2 | 2 | 2 | 2 | 2 | 2 | 2 | 2 | 2 | 2 | 2 | 2 | 2 |
| Insoluble sulfur | 4.5 | 4.5 | 4.5 | 4.5 | 4.5 | 4.5 | 4.5 | 4.5 | 4.5 | 4.5 | 4.5 | 4.5 | 4.5 | 4.5 |
| Vulcanization accelerator | 1 | 1 | 1 | 1 | 1 | 1 | 1 | 1 | 1 | 1 | 1 | 1 | 1 | 1 |
| Methylene donor | 4 | 4 | 4 | 4 | 4 | 4 | 4 | 4 | 4 | 4 | 4 | 4 | 4 | 4 |
| Arrangement of rubber sheet | FIG. | FIG. | FIG. | FIG. | FIG. | FIG. | FIG. | FIG. | FIG. | FIG. | FIG. | FIG. | FIG. | FIG. |
| | 2 | 2 | 2 | 2 | 2 | 2 | 2 | 2 | 2 | 2 | 3 | 4 | 5 | 2 |
| Evaluation | | | | | | | | | | | | | | |
| Fatigue resistance performance | 100 | 105 | 138 | 137 | 139 | 131 | 113 | 114 | 114 | 116 | 138 | 138 | 138 | 153 |
| (index) | | | | | | | | | | | | | | |
| Drum durability | Stan- | C | B | B | B | B | B | B | B | B | B | A | A | A |
| | dard | | | | | | | | | | | | | |

### DESCRIPTION OF REFERENCE NUMERALS AND SIGNS

4: Bead core

5: Carcass ply

5B: Turned-up portion

5E: Turned-upend portion

8: Bead filler

9: Rubber chafer

10, 10A, 10B: Rubber sheet

1. A method for manufacturing a pneumatic tire, the method comprising:
preparing a rubber sheet using a wet masterbatch containing natural rubber and/or polyisoprene rubber and carbon black,
arranging the rubber sheet on at least one of front and back sides at a turned-up end portion of a carcass ply in manufacturing a green tire in which the carcass ply is turned up around a bead core, and
vulcanization-molding the green tire obtained.

2. The method for manufacturing a pneumatic tire according to claim 1, wherein a peptizer is added in a process of preparing the wet masterbatch using a rubber latex solution containing natural rubber and/or polyisoprene rubber and a slurry solution containing carbon black.

3. The method for manufacturing a pneumatic tire according to claim 2, wherein the amount of the peptizer added is from 0.01 to 2 parts by mass per 100 parts by mass of the natural rubber and/or polyisoprene rubber.

4. The method for manufacturing a pneumatic tire according to claim 1, wherein the process of preparing the wet masterbatch comprises:
a step (A) of producing a slurry solution containing carbon black having adhered thereto rubber latex particles by adding a part of the rubber latex solution containing natural rubber and/or polyisoprene rubber in dispersing carbon black in a dispersion medium,
a step (B) of producing a rubber latex solution containing carbon black having adhered thereto rubber latex particles by mixing the slurry solution with the remaining rubber latex solution, and
a step (C) of coagulating the carbon black-containing rubber latex solution by adding an acid,
wherein pH of the carbon black-containing rubber latex solution before adding the acid is adjusted to from 7.5 to 8.5.

5. The method for manufacturing a pneumatic tire according to claim 4, wherein pH of the slurry solution containing carbon black having adhered thereto rubber latex particles, obtained after the step (A) is adjusted to 7.1 or higher.

6. The method for manufacturing a pneumatic tire according to claim 4, wherein a peptizer is added in mixing the slurry solution with the remaining rubber latex solution in the step (B).

7. The method for manufacturing a pneumatic tire according to claim 1, wherein the rubber sheet is arranged so as to wrap the turned-up end portion of the carcass ply.

8. The method for manufacturing a pneumatic tire according to claim 1, wherein the thickness of the rubber sheet is from 0.1 to 5.0 mm.

9. A pneumatic tire comprising a bead core embedded in a bead portion, a carcass ply turned up and locked around the bead core, and a rubber sheet arranged on at least one of front and back sides at a turned-up end portion of the carcass ply,
wherein the rubber sheet comprises a rubber composition containing a wet masterbatch containing natural rubber and/or polyisoprene rubber and carbon black.

10. The pneumatic tire according to claim 9, wherein the rubber sheet is arranged so as to wrap the turned-up end portion of the carcass ply.
